(19) United States
(12) Patent Application Publication
(10) Pub. No.: US 2005/0281911 A1
(43) Pub. Date: Dec. 22, 2005

(54) Self macerating-fermenting vessel

(75) Inventors: Raul Del Monte, Guaymallen-Mendoza (AR); Carlos Catania, Guaymallen-Mendoza (AR); Maria Silvia Avagnina, Guaymallen-Mendoza (AR)

Correspondence Address: NORRIS, MCLAUGHLIN & MARCUS, P.A., 875 THIRD AVE, 18TH FLOOR, NEW YORK, NY, 10022, US

(73) Assignee: Instituto Nacional de Tecnologia Agropecuaria, Buenos Aires (AR)

(21) Appl. No.: 10/872,020

(22) Filed: Jun. 18, 2004

(51) Int. Cl. C12C 11/00

(52) U.S. Cl. 426/11

(57) ABSTRACT

A cylindrical fermentation tank having a plurality of inner guides defining pathways for vertical movement of at least one grid connected to a rod axially extending into the tank and vertically actuated by a pneumatic cylinder, wherein the grid has an outer diameter and the tank has an inner diameter, with the outer diameter of said grid being slightly smaller than the inner diameter of the fermentation tank. The upper grid comprises a tubular frame allowing the flow of heat/coolant liquid/gas.

### BACKGROUND OF THE INVENTION

1. Field of the Invention

The present invention generally relates to the wine making field and more precisely to a self macerating-fermenting vessel.

Red wine is typically made by crushing dark-skinned grapes and extracting color and flavor components from the grape skins and pulp by allowing the crushed grapes, including their juice, to sit for a period of time. This extraction time is followed by a fermentation stage where yeast converts sugar in the grape juice to alcohol and carbon dioxide. The fermentation can also facilitate in extracting flavor and color from the skins. This process is often referred to as “maceration”. The wine or partially fermented grape juice (“must”) is typically pressed from the skins, stems, and other large solids, and transferred to a secondary vessel where further processing occurs.

During the extraction period the large solids typically float to the surface of the crushed grapes to form a “cap”. This cap can be relatively thick and portions can partially dry out, which diminishes extraction. If fermentation is occurring, the carbon dioxide formed by the yeast can also carry solids to the surface because the gas bubbles nucleate on the solids and carry them to the top of the liquid. Heat is also generated during fermentation and the drier portion of the cap can overheat, generating undesirable flavor components.

2. Description of the Prior Art

Many techniques have been developed to keep the cap moist to improve the extraction of flavor and color. The “grape stomp”, for example, is directed at submerging the cap into the must, rather than crushing fresh grapes, as is often thought. Other manual methods exist, such as large plungers that the winemaker can use to push portions of the cap into the must. Many of these methods can be tedious and imprecise. The imprecision can lead to a lack of process control that can affect the quality of the wine produced. While other methods have been developed to assist in the extraction and fermentation processes of red wine making, these technologies do not over come the know drawbacks.

### SUMMARY OF THE INVENTION

It is therefore one object of the present invention to provide a self macerating-fermenting vessel for automatically managing the motion of the cap improving the solid-juice contact.

It is still another object of the present invention to provide a self macerating-fermenting vessel for improving the organolepctic characteristics of the resulting wine.

It is a further object of the present invention to provide a self macerating-fermenting vessel for improving efficiency in the maceration process of the must in order to provide a better enological quality in the resulting wine.

It is another object of the present invention to provide a self macerating-fermenting vessel comprising a cylindrical fermentation tank having a plurality of inner guides defining pathways for vertical movement of at least one grid connected to a rod axially extending into the tank and vertically actuated by a pneumatic cylinder, wherein the grid has an outer diameter and the tank has an inner diameter, with the outer diameter of said grid being slightly smaller than the inner diameter of the fermentation tank.

The above and other objects, features and advantages of this invention will be better understood when taken in connection with the following description.

### DESCRIPTION OF THE PREFERRED EMBODIMENTS

Further characteristics and advantages of the invention will become clear from the following detailed description, given with reference to the appended drawings, in which:

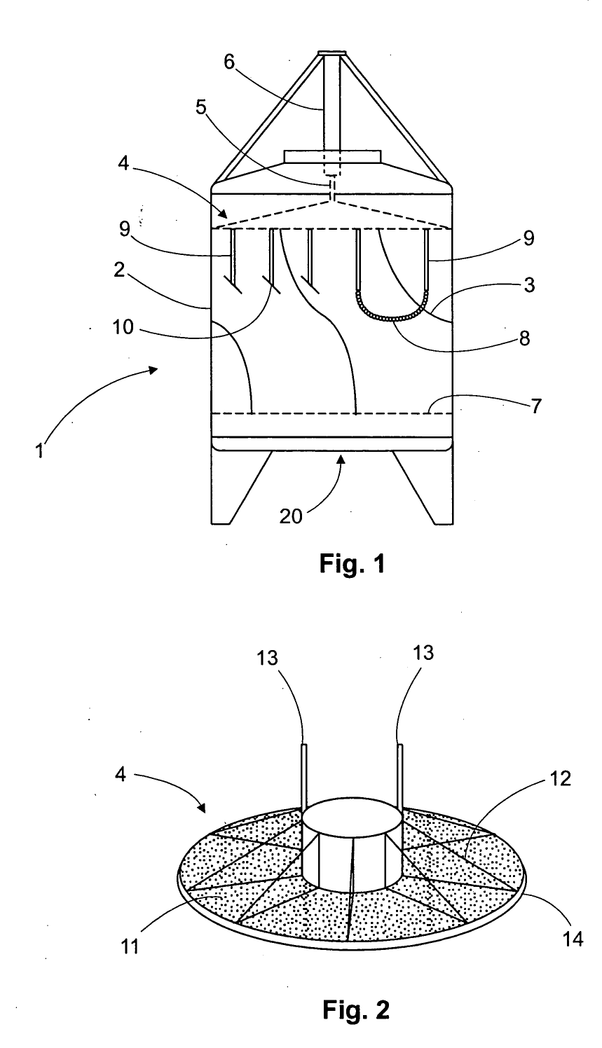

FIG. 1 is an schematic frontal view of the self macerating-fermenting vessel according to the invention.

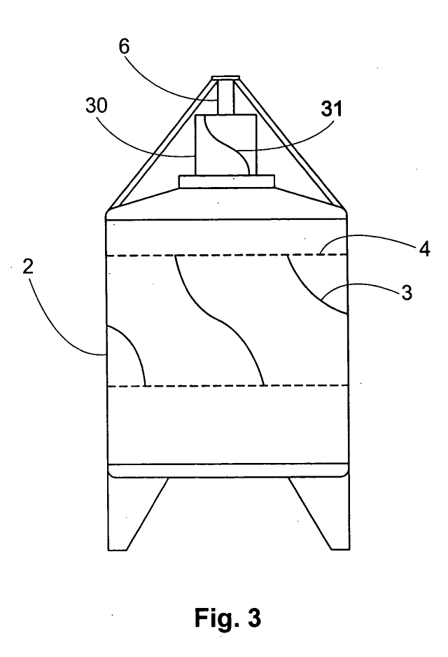

FIG. 2 is a perspective view of the grid used in the self macerating-fermenting vessel of FIG. 1.

FIG. 3 is an schematic frontal view of the self macerating-fermenting vessel showing the helical guides included in the vessel.

With reference to the drawings a self macerating-fermenting vessel is generally indicated 1. The vessel 1 comprises a cylindrical fermentation tank 2 having a plurality of inner guides 3 defining pathways for vertical movement of at least an upper grid 4 connected to a rod 5 axially extending into the tank 2 and vertically actuated by a pneumatic cylinder 6. The inner guides 3 define a sinusoidal pathway for generating the rotation of the upper grid 4 while moving vertically.

The upper grid 4 has an outer diameter and the tank 2 has an inner diameter, with the outer diameter of said grid being slightly smaller than the inner diameter of the fermentation tank. The upper grid comprises a peripheral rim 14 made of Teflon®. This rim 14 works as a seal between the perimeter of the upper grid 4 and the inner wall of the tank 2, forcing the cap and the liquid to only pass through the upper grid 4.

As it can be seen from FIG. 1, the general conformation of the vessel 1 is the same as many other fermentation tank know in the art. Therefore, some common parts such as intake ducts, delivery ducts, and so, are not described nor showed for the sake of clarity, since those common parts are already known to the skilled in the art.

Still referring to FIG. 1, a base grid 7 is located near the bottom 20 of the tank 2. The base grid 7 is similar to the upper grid 4 and is commonly used in at least three basic operations, which are: raising the sheet of crushed grape skin when said sheet is rapidly lowered by the movement of grid 4; separation of the seeds from the skins; and providing a smooth pressing of the grape's skin while in the process of removing the wine from the vessel 1. Said base grid 7 can be moved longitudinally to several positions either upwardly or downwardly.

The base grid 7 can be coupled to the upper grid by means of a chain 8, that is, both base grid 7 and upper grid 4, will move in the same rotating motion by means of the helical guides 3 while the cylinder 6 is actuated. This chain 8 can also be used as an agitating mean which are a plurality of rods 9 projecting downwardly from said upper grid 4. The agitating means attached from bottom end of said rods 9, can be any agitating mean such as flapper 10, chains 8, or a combination thereof. The agitating means are provided to improve the action of mixing the cap with the liquid in order to obtain a better wine.

Referring now to FIG. 2, the upper grid 4 is made of a mesh 11 allowing the flow of the liquid while agitating and submerging the cap made inside the tank 2. A tubular frame 12 is radially projecting from the center of the at least the upper grid. This tubular frame operates as a heat exchanger regulating the temperature of the must inside the vessel. A warmth/cooling device (not shown) can be coupled through pipes 13 to the tubular frame 12 for injecting water or any other liquid or gas flowing inside the tubular frame to either warm or cool the must while in the process of making wine.

Making reference to FIG. 3, the fermentation tank 2 includes the already mentioned helical guides 3. In a further embodiment the piston of the cylinder 6 can include a perimeter rib coupling helical guides 31 specially made inside the pressure tank 30 of said cylinder 30.

The use of a modified cylinder as the one mentioned above allows the use of the helical motion upper grid in any fermentation tank, and by no means the inner wall of said tank must be modified to include helical guides, as the one illustrated in FIG. 1.

During the maceration-fermentation process the cylinder 6 is actuated moving the upper grid 4 up and down guided by the helical inner guides 3. As mentioned before, the helical guides 3 generates the rotation of the upper grid 4 agitating and mixing the cap with the liquid improving the maceration-fermentation process. While its not shown, the tank 2 includes a outer control visor to oversee the process of agitation trough the complete cycle of the maceration-fermentation process. The motion inside the tank is extremely smooth and runs along the total height of the tank maintaining the contact between the liquid and the cap during the whole process.

Basically, the use of the vessel can be described in very few steps. Firstly, the crushing grapes into must should be done in order to place the must into the fermentation tank. Afterwards (according to the kind of grape) the must has to be allowed to ferment while actuating the pneumatic cylinder moving the grid up and down along the helical guides causing the grid to rotate; generating a vertical helical motion inside the tank mixing and agitating the cap with the liquid and generating a slight pressure within the tank using the base grid to speed up the extraction process of the wine.

While the invention has been described above with reference to specific embodiments, other embodiments, modifications, or adaptations may become apparent to those skilled in the art. Therefore, the above embodiments are exemplary and the invention is to be determined according to the following claims.

1. A self macerating-fermenting vessel comprising:
a cylindrical fermentation tank having a plurality of inner guides defining pathways for vertical movement of at least an upper grid connected to a rod axially extending into the tank and vertically actuated by a pneumatic cylinder, wherein the upper grid has an outer diameter and the tank has an inner diameter, with the outer diameter of said grid being slightly smaller than the inner diameter of the fermentation tank.

2. The vessel according to claim 1, wherein a base grid is located near the bottom of the tank.

3. The vessel according to claim 1, wherein said guides define a sinusoidal pathway for generating the rotation of the grid while moving vertically.

4. The vessel according to claim 3, wherein the guides defines a helical movement for the grid inside the tank.

5. The vessel according to claim 1, wherein the grid comprises a peripheral rim made of Teflon®.

6. The vessel according to claim 1, wherein the tank comprises an outer control visor.

7. The vessel according to claim 1, wherein a plurality of rods projects downwardly from said grid.

8. The vessel according to claim 7, wherein each of said rods includes, at a bottom end thereof, at least one of the following means, a flapper, a chain, or a combination thereof.

9. The vessel according to claim 1, wherein the grid comprises a tubular structure defining pathways for heating or coolant liquids.

10. A method for making wine in a self macerating-fermenting vessel comprising:
a cylindrical fermentation tank having a plurality of inner guides defining pathways for vertical movement of at least one grid connected to a rod axially extending into the tank and vertically actuated by a pneumatic cylinder, wherein the grid has an outer diameter and the tank has an inner diameter, with the outer diameter of said grid being slightly smaller than the inner diameter of the fermentation tank, the method comprising the steps of:
a) crushing grapes into must;
b) placing the must into the fermentation tank;
c) allowing the must to ferment;
d) actuating the pneumatic cylinder to move the grid down along the guides and to cause the grid to rotate;
e) generating a vertical helical motion of said grid inside the tank
f) generating a slight pressure within the tank using the grid to speed up the extraction process of the

11. A method for making wine in a self macerating-fermenting vessel comprising:
a cylindrical fermentation tank having a plurality of inner guides defining pathways for vertical movement of at least one grid connected to a rod axially extending into the tank and vertically actuated by a pneumatic cylinder, wherein the grid has an outer diameter and the tank has an inner diameter, with the outer diameter of said grid being slightly smaller than the inner diameter of the fermentation tank, the method comprising the steps of:
g) crushing grapes into must;
h) placing the must into the fermentation tank;
i) allowing the must to ferment;
j) actuating the pneumatic cylinder to move the grid down along the guides and to cause the grid to rotate;
k) generating a vertical helical cycle motion of said grid inside the tank
l) applying heat of cold through the tubular frames of the upper grid during the cycle motion.
